(19) United States
(12) Patent Application Publication
(10) Pub. No.: US 2015/0146079 A1
(43) Pub. Date: May 28, 2015

(54) ELECTRONIC APPARATUS AND METHOD FOR PHOTOGRAPHING IMAGE THEREOF

(71) Applicant: SAMSUNG ELECTRONICS CO., LTD., Suwon-si (KR)

(72) Inventor: Tae-hyun Kim, Seongnam-si (KR)

(21) Appl. No.: 14/296,770

(22) Filed: Jun. 5, 2014

(30) Foreign Application Priority Data
Nov. 27, 2013 (KR) 10-2013-0145181

(51) Int. Cl. H04N 5/232

(52) U.S. Cl. CPC H04N 5/23212; H04N 5/23293
USPC 348/345

(57) ABSTRACT

A method for photographing an image by an electronic apparatus includes displaying an image as a live view; setting a plurality of focus areas from the image; when a photographing command is received, obtaining an Auto Focus (AF) evaluation value of a photographed image; detecting a plurality of focus positions corresponding to the plurality of focus areas by analyzing the AF evaluation value; and obtaining and storing a plurality of images corresponding to the plurality of detected focus positions.

### CROSS-REFERENCE TO RELATED APPLICATIONS

This application claims the priority benefit under 35 U.S.C. §119 from Korean Patent Application No. 10-2013-0145181, filed on Nov. 27, 2013 in the Korean Intellectual Property Office, the disclosure of which is incorporated herein by reference in its entirety.

### BACKGROUND

1. Field

Embodiments generally relate to an electronic apparatus and a method for photographing an image thereof, and more particularly, to an electronic apparatus which faciliatates easily photographing a plurality of images having different focuses and a method for photographing an image thereof.

2. Description of the Related Art

With the improvement of a photographing sensor of an electronic apparatus that performs photographing, shutter lag, that is, a delay time between a point in time when a photographing command where a user presses a shutter button is input and a point in time when an image is actually photographed has been shortened. Moreover, it becomes possible to embody a zero shutter lag technology where no shutter lag occurs.

In addition, when a user wishes to photograph a plurality of images having different focuses in an image displayed as a live view in an environment where shutter lag exists, the user should photograph the images by detecting positions of the focuses in a live view mode and changing a photographing sensor, which causes time loss.

That is, in order to obtain an image where a part of the photographed image is in focus, it is required to analyze an Auto Focus (AF) evaluation value and detect a position where a frequency of the AF evaluation value is highest. However, in the environment where the shutter lag exists, it is required to detect the position where the frequency of the AF evaluation value is highest and then change a photographing sensor in order to photograph an image, which causes a problem of time loss.

### SUMMARY

The present disclosure has been provided to address the aforementioned and other problems and disadvantages occurring in the related art, and an aspect of the present disclosure provides an electronic apparatus which facilitates easily photographing a plurality of images having different focuses and a method for photographing an image thereof.

A method for photographing an image by an electronic apparatus according to an exemplary embodiment includes displaying an image as a live view, and setting a plurality of focus areas from the image. When a photographing command is received, the method includes obtaining an Auto Focus (AF) evaluation value of a photographed image, detecting a plurality of focus positions corresponding to the plurality of focus areas by analyzing the AF evaluation value, and obtaining and storing a plurality of images corresponding to the plurality of detected focus positions.

The method may further include detecting a focus position where a value equal to a sum of obtained AF evaluation values of the photographed image multiplied by predetermined weight values is a maximum. In addition, the obtaining and storing may include obtaining and storing an image corresponding to the focus position where a value equal to a sum of obtained AF evaluation values of the photographed image multiplied by predetermined weight values is a maximum.

The detecting may include detecting a focus position where the AF evaluation value has a maximum value as the plurality of focus positions.

The method may further include displaying the plurality of obtained and stored images, and receiving a selection of at least one image from among the plurality of displayed images. In addition, the obtaining and storing may include storing only the selected at least one image.

The detecting the plurality of focus positions may include, when a command of designating a plurality of focus areas from the image displayed as a live view is received, detecting the plurality of focus positions from the designated plurality of focus areas.

The predetermined weight values may include a weight value of a highest value in a center of an image.

The detecting may include detecting the plurality of focus positions by analyzing the AF evaluation value while moving from a first point to a second point of the image.

An electronic apparatus according to an exemplary embodiment includes a photographing unit configured to photograph an image, a display configured to display a live view and a photographed image, a shutter control configured to receive a photographing command, a storage configured to store the image, and an image processor configured to obtain and analyze an Auto Focus (AF) evaluation value of the image when the photographing command is received and detect a plurality of focus positions from the image. The apparatus also includes a controller configured to control the apparatus to obtain a plurality of images corresponding to the plurality of detected focus positions and store the images in the storage.

The image processor may detect a focus position where a value equal to a sum of obtained AF evaluation values of the image multiplied by predetermined weight values is a maximum. In addition, the controller may control the apparatus to obtain and store an image corresponding to the focus position where a value equal to a sum of obtained AF evaluation values of the image multiplied by predetermined weight values is a maximum.

The image processor may detect a position where the AF evaluation value has a maximum value as one of the plurality of focus positions.

The apparatus may further include a user input unit. In addition, the user input unit, when the plurality of obtained and stored images are displayed through the display, may receive a selection of at least one image from among the displayed images, and the storage may store only the selected at least one image.

When a command of designating a plurality of areas from the image displayed as a live view is received, the image processor may detect the plurality of focus positions from the plurality of designated areas.

The predetermined weight values may include a weight value of a highest value in a center of an image.

The image processor may detect the plurality of focus positions by analyzing the AF evaluation value while moving from a first point to a second point of the image.

According to various exemplary embodiments disclosed herein, an electronic apparatus which easily photographs a plurality of images having different focuses and a method for photographing an image thereof may be provided.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a structure of an image photographing apparatus according to an exemplary embodiment;

FIG. 2 is a diagram illustrating a method of setting a plurality of focus positions according to an exemplary embodiment;

FIG. 3 is a diagram illustrating a method of detecting a plurality of focus positions by analyzing an Auto Focus (AF) evaluation value according to an exemplary embodiment;

FIGS. 4 and 5 are diagrams illustrating an image photographing apparatus which obtains and displays a plurality of images corresponding to the plurality of detected focus positions according to various exemplary embodiments; and

FIGS. 6 and 7 are flow charts illustrating methods for photographing an image according to various exemplary embodiments.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

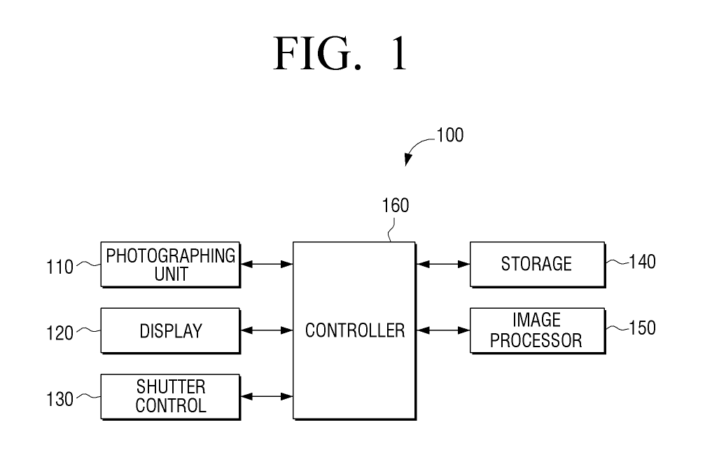

FIG. 1 is a block diagram illustrating a structure of an image photographing apparatus 100 according to an exemplary embodiment. As illustrated in FIG. 1, the image photographing apparatus 100 includes a photographing unit 110, a display 120, a shutter control 130, a storage 140, an image processor 150, and a controller 160. In this case, the image photographing apparatus 100 may be a camera, but is not limited thereto. The image photographing apparatus 100 may be embodied as a variety of electronic apparatuses and devices, for example, as a mobile phone, a tablet Personal Computer (PC), a digital camera, a camcorder, a laptop PC, a Personal Digital Assistant (PDA), and the like, which is equipped with the photographing unit 110.

The photographing unit 110 is a configuration for photographing an image. That is, the photographing unit 110 may receive an image of a subject by converting an optical signal that is input through a lens into an electronic signal by using an image sensor. In this case, the subject refers to all objects including a main subject and a background within a photographed image.

The display 120 is a configuration for displaying an image which is photographed by the photographing unit 110 or displaying an image stored in the storage 140.

That is, the display 120 displays an image that is input through the photographing unit 110. The display 120 may display am image which is currently input as a live view, display an image which is obtained by a photographing command of a user, or display an image which a user has downloaded through wireless communication or stored in the storage 140 by connecting the image photographing apparatus 100 to another electronic apparatus.

In addition, the display 120 may display a plurality of images stored in the storage 140 simultaneously. Further, the display 120 may display a user interface (UI) for convenience in user manipulation. That is, the display 120 may display a plurality of images simultaneously, and may display UI for receiving a selection of at least one image from among a plurality of images from a user.

The shutter control 130 is a configuration for receiving a photographing command. That is, the shutter control 130 may be included in a part of the image photographing apparatus 100 as a hardware configuration, e.g., a shutter button. Accordingly, the image photographing apparatus 100 may receive a photographing command from a user through a user manipulation of pressing or touching the shutter control 130. In addition, when the shutter control 130 includes a microphone, the shutter control 130 may receive a photographing command through a user voice such as ‘click’ or ‘kimchi,’ etc.

The storage 140 is a configuration for storing various software modules for operating the image photographing apparatus 100, images, and the like. In particular, the storage 140 may store images even when a photographing command is not input through the shutter control 130. For example, when a plurality of focus positions are detected by analyzing an AF evaluation value according to a method which will be described below, the storage 140 may store a plurality of images corresponding to the plurality of detected focus positions.

A focus position refers to a position in which a photographed image is focused accurately. Accordingly, an image corresponding to the focus position refers to an image which is accurately focused.

The image processor 150 may detect a plurality of focus positions by obtaining and analyzing an AF evaluation value of an image when a photographing command is input through the shutter control 130. That is, the image processor 150 may detect a position in which an image is accurately focused.

To be specific, the image processor 150 may obtain an AF evaluation value. In the case of a general subject, the more accurately a subject is focused, the higher the AF evaluation value increases. Accordingly, a position where the AF evaluation value has a maximum value is detected as a focus position. That is, the image processor 150 may detect a position where the AF evaluation value has a maximum value as a focus position by analyzing an AF evaluation value of an image.

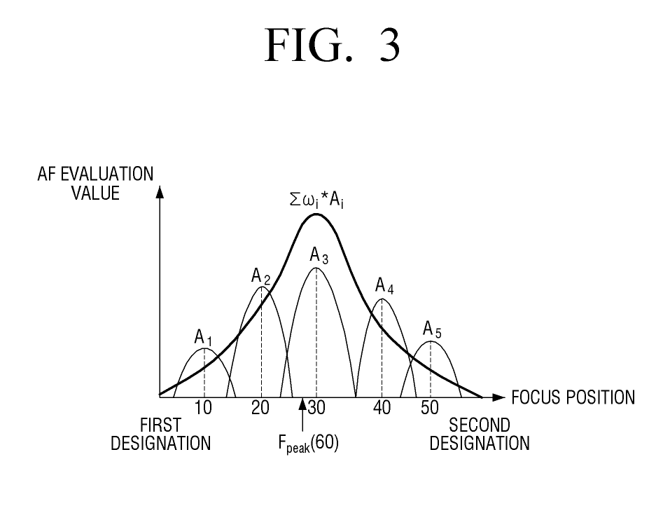

As illustrated in FIG. 3, the image processor 150 may detect a plurality of focus positions (e.g., focus positions corresponding to A1, A2, A3, A4, and A5). When a user wishes to obtain an image whose focus is at a different position, the image processor 150 may set a plurality of areas in order to obtain an image which focuses on different subjects by a function of recognizing a subject of the image photographing apparatus 100 or a user command. The image processor 150 may detect a point where an AF evaluation value has a maximum value in the plurality of areas (that is, an inflection point where a slope becomes 0) as a focus position of each area of the plurality of areas.

The image processor 150 may detect a position where a value equal to the sum of the obtained AF evaluation values (e.g., Aᵢ) multiplied by predetermined weight values (e.g., ωᵢ) has a maximum value as a focus position. For example, a user photographs an image by disposing a subject on which the user wishes to focus accurately on a center of the display 120 in many cases. Accordingly, the image photographing apparatus 100 may set that a center of an image has a high weight value. In addition, the image processor 150 may detect the position where a value equal to the sum of the obtained AF evaluation values multiplied by predetermined weight values has a maximum value as a focus position.

The controller 160 is a configuration for controlling overall operations of the image photographing apparatus 100. Specially, the controller 160 may obtain an image corresponding to a focus position detected by the image processor 150. In addition, the controller 160 may control the storage 140 to store the obtained image. That is, even though a user command for storing the obtained image is not input, the controller 160 may control to store the image corresponding to the detected focus position in the storage 140.

When the image processor 150 detects a plurality of focus positions, the controller 160 may obtain a plurality of images which correspond to the plurality of focus positions respectively. In addition, the controller 160 may control the storage 140 to store the plurality of obtained images.

Further, the controller 160 may control the storage 140 to obtain and store an image corresponding to a focus position where a value equal to the sum of the obtained AF evaluation values (e.g., Aᵢ) multiplied by predetermined weight values (e.g., ωᵢ) has a maximum value. For example, when a weight value in a center of an image is highest and weight values become lower as distance from the center of the image increases, the image processor 150 multiplies an AF evaluation value by each of the weight values, and detects a position where a value multiplied the AF evaluation value by each of the weight values has a maximum value as a focus position. By doing so, the controller 160 may obtain an image corresponding to the focus position. Specific exemplary embodiments of detecting a focus position will be described below.

Meanwhile, the image photographing apparatus 100 may further include a user input unit (not shown). When the display 120 displays a plurality of images, the user input unit (not shown) may receive a user command for selecting at least one image from among the displayed images. When the display 120 includes a touch panel, the user input unit (not shown) may be included in the display 120. In addition, the user command for selecting the display image may be input in a form of touch input.

However, a touch command is merely an exemplary embodiment, and a user command may be embodied as various exemplary embodiments such as a command of displaying a plurality of images sequentially including numbers, a voice command of selecting at least one of a plurality of images by inputting numbers by voice, etc.

When at least one image is selected by a user command from among a plurality of images, the storage 140 may store only the selected image. That is, the storage 140 may store an image corresponding to a focus position detected by the controller 160 even when no user command is input. However, when the display 120 displays a plurality of images corresponding to the detected focus position and a user command of selecting at least one image from among the plurality of images is input through the user input unit, the storage 140 may delete unselected images, and may store only the selected image. In addition, the display 120 may display a UI of inquiring whether a user wishes to delete the unselected images.

When a user command of designating a plurality of areas in the image displayed as a live view is input, the image processor 150 may detect a plurality of focus positions from the plurality of designated areas.

To be specific, the image processor 150 may automatically detect an area from which a focus position is detected in the displayed image, and when a photographing command is input through the shutter control 130, detect the focus position which focuses accurately by analyzing an AF evaluation value of an image when the photographing command is input.

When the area from which the focus position is detected is designated by a user, and a photographing command is input through the shutter control 130, the image processor 150 may detect the focus position which focuses accurately from the area designated by the user.

In addition, the image processor 150 may analyze the AF evaluation value of the image when the photographing command is input while moving from a first point to a second point of the image. For example, the image processor 150 may analyze the AF evaluation value while moving from a point where a subject is close to the image photographing apparatus 100 to a point where the subject is far from the image photographing apparatus 100. Alternatively, the image processor 150 may analyze the AF evaluation value while moving from a left side to a right side or moving from the right side to the left side of the photographed image.

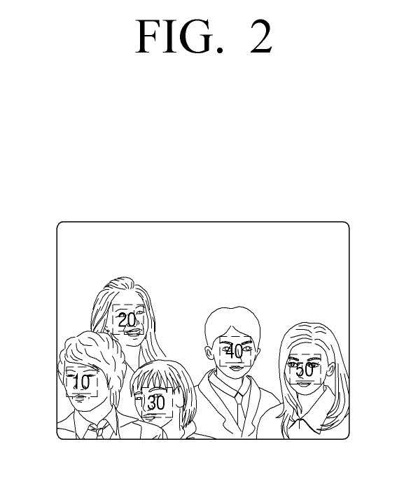

Hereinafter, a method for photographing an image is described in detail with reference to FIGS. 2 to 5.

FIG. 2 is a diagram illustrating a method of setting a plurality of focus positions according to an exemplary embodiment. FIG. 2 shows a display which displays an image whose subject is five people as a live view. Each of a plurality of boxes 10, 20, 30, 40, and 50 of the people illustrated in FIG. 2 refers to an area where a focus position is detected. That is, when a subject of an image is a person, it is common to focus on a face of the person. Accordingly, the controller 160 may control to recognize a face of person and focus on the face automatically.

In addition, the controller 160 may set an area which is detected as a focus position by a user command. For example, when the display 120 includes a touch panel, a user is able to set at least one area by touching an area on which the user wishes to focus in the displayed image.

That is, when the area which is detected as a focus position is set automatically or by a user command, each area may be expressed as the boxes 10, 20, 30, 40, and 50 as illustrated in FIG. 2. However, it is merely an exemplary embodiment, and the area may be displayed in various forms such as figures or colors, which are capable of informing that the area will be detected as a focus position.

When a face of each person is set to be detected as a focus position, and a photographing command is input through the shutter control 130, the image processor 150 obtains an AF evaluation value as illustrated in FIG. 3.

That is, the AF evaluation value is a frequency value which has a high value when a subject is focused accurately. Accordingly, in the areas 10, 20, 30, 40, and 50 which are set as the areas to be detected as a plurality of focus positions, the AF evaluation value of a position where a subject is focused accurately is highest. Accordingly, the image processor 150 analyzes the AF evaluation value, and detects a position where a slope becomes 0, that is, a position having an inflection point while moving from the first point to the second point of the image when the photographing command is input. That is, the image processor 150 detects a position where the AF evaluation value has a maximum value in each of the set areas 10, 20, 30, 40, and 50 as a focus position where a subject is focused accurately. The controller 160 obtains a plurality of images corresponding to each of the focus positions. In addition, the controller 160 may control the storage 140 to store the plurality of obtained images.

Meanwhile, the image processor 150 may detect a position where a value equal to a sum of the obtained AF evaluation values multiplied by predetermined weight values is highest as a focus position. For example, a user photographs an image by disposing a subject on which the user wishes to focus accurately on a center of the display 120 in many cases. Accordingly, the image photographing apparatus 100 may set that a center of an image has a high weight value. In addition, the image processor 150 may detect the position where a value equal to a sum of the obtained AF evaluation values multiplied by predetermined weight values is highest as a focus position.

That is, as illustrated in FIG. 3, the image photographing apparatus 100 may set a third area 30 from among a plurality of areas to have a high weight value since the third area 30 is the center of the image. In addition, the AF evaluation value is highest in the third area 30, and a value equal to a sum of the obtained AF evaluation values multiplied by predetermined weight values is calculated as the highest value in the third area 30. Accordingly, the image processor 150 may detect a position where a slope becomes 0, that is, a position having an inflection point as a focus position. The controller 160 may control the storage 140 to obtain an image corresponding to the area detected as the focus position by the image processor 150 and store the obtained image.

Setting a weight value of a center of an image to have the highest value is merely an exemplary embodiment, and the controller 160 may set a weight value of an image in various methods including detecting a part where a subject is usually located from an image and setting a weight value of the detected part to have a high value.

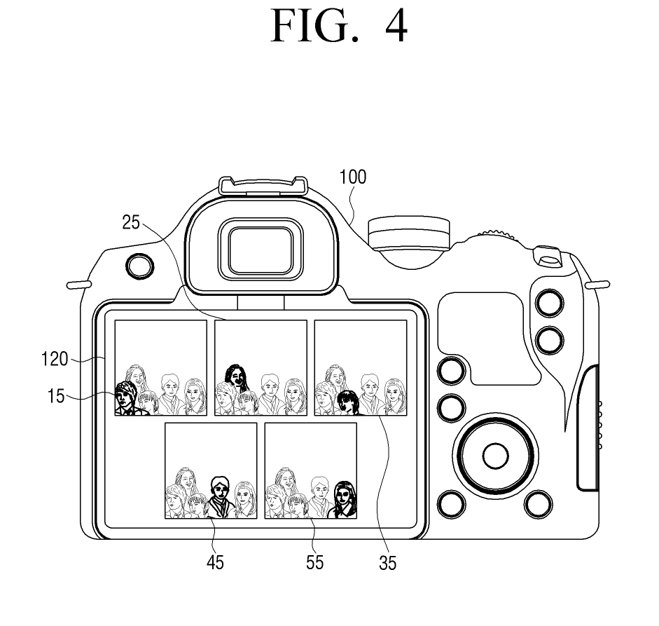

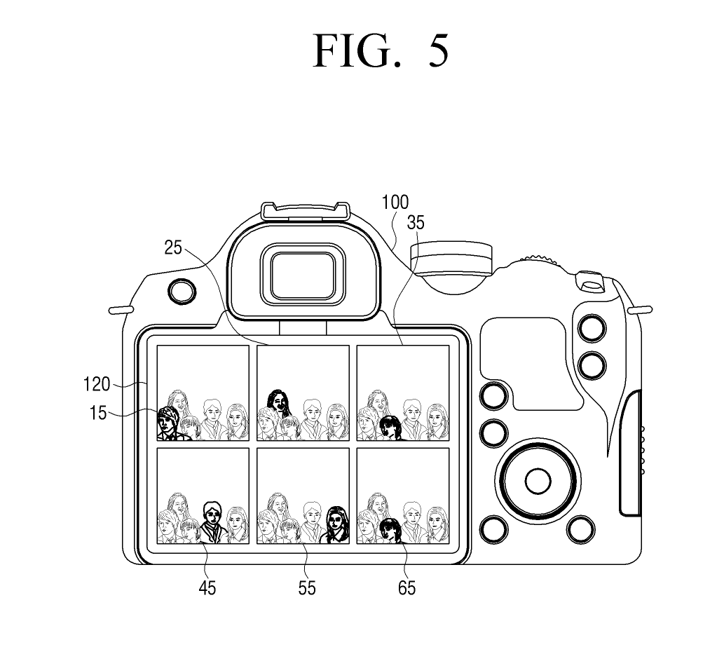

FIGS. 4 and 5 are diagrams illustrating an image photographing apparatus which obtains and displays a plurality of images corresponding to a plurality of detected focus positions according to various exemplary embodiments.

That is, FIG. 4 is a diagram illustrating the image photographing apparatus 100 which displays a plurality of images corresponding to the focus positions obtained by the controller 160, when the image processor 150 detects a position where an AF evaluation value has a maximum value in each of the set areas 10, 20, 30, 40, and 50 as a focus position which focuses accurately.

To be specific, the display 120 may display a first image 15 corresponding to a focus position where an AF evaluation value has a maximum value in the first area 10, display a second image 25 corresponding to a focus position where an AF evaluation value has a maximum value in the second area 20, and display a third image 35 corresponding to a focus position where an AF evaluation value has a maximum value in the third area 30. In addition, the display 120 may display a fourth image 45 corresponding to a focus position where an AF evaluation value has a maximum value in the fourth area 40, and display a fifth image 55 corresponding to a focus position where an AF evaluation value has a maximum value in the fifth area 50.

Meanwhile, the display 120 may display a UI of inquiring whether a user wishes to store all of a plurality of displayed images. In addition, the display 120 may display a UI for receiving a selection of at least one image from among the plurality of images.

When a user command for storing all or a part of the plurality of displayed images is input from the user through the aforementioned UI, the storage 140 may store all of the images or may store only a part of the images while deleting some images according to the user command.

Meanwhile, FIG. 5 is a diagram illustrating the image photographing apparatus 100 which displays a plurality of images corresponding to the focus positions obtained by the controller 160 when the image processor 150 detects a position where an AF evaluation value has a maximum value in each of the set areas 10, 20, 30, 40, and 50 as a focus position which a focuses accurately, and detects a position where a value equal to the sum of the obtained AF evaluation values multiplied by predetermined weight values is highest as a focus position.

To be specific, the image processor 150 detects a point where an AF evaluation value has a maximum value in the five areas which are set in order to detect a focus position as a focus position. When the detection of the focus positions is finished simultaneously or respectively in the five areas, the image processor 150 detects a position where a value equal to the sum of the obtained AF evaluation values multiplied by the predetermined weight values has a maximum value as another focus position.

Accordingly, the controller 160 may control to obtain six images corresponding to six focus positions and store the six obtained images in the storage 140. In addition, the display 120 may display a plurality of images corresponding to the focus positions obtained by the controller 160.

To be specific, the display 120 may display the first image 15 corresponding to the focus position where the AF evaluation value has the maximum value in the first area 10, display the second image 25 corresponding to the focus position where the AF evaluation value has the maximum value in the second area 20, and display the third image 35 corresponding to the focus position where the AF evaluation value has the maximum value in the third area 30. In addition, the display 120 may display the fourth image 45 corresponding to the focus position where the AF evaluation value has the maximum value in the fourth area 40, display the fifth image 55 corresponding to the focus position where the AF evaluation value has the maximum value in the fifth area 50, and display a sixth image 65 corresponding to a focus position where a value equal to the sum of the obtained AF evaluation values multiplied by predetermined weight values has a maximum value.

Meanwhile, the display 120 may display a UI of inquiring whether a user wishes to store all of a plurality of displayed images. In addition, the display 120 may display a UI for receiving a selection of at least one image from among the plurality of images.

When a user command for storing all or a part of the plurality of displayed images is input from the user through the aforementioned UI, the storage 140 may store all of the images or may store only a part of the images while deleting some images according to the user command.

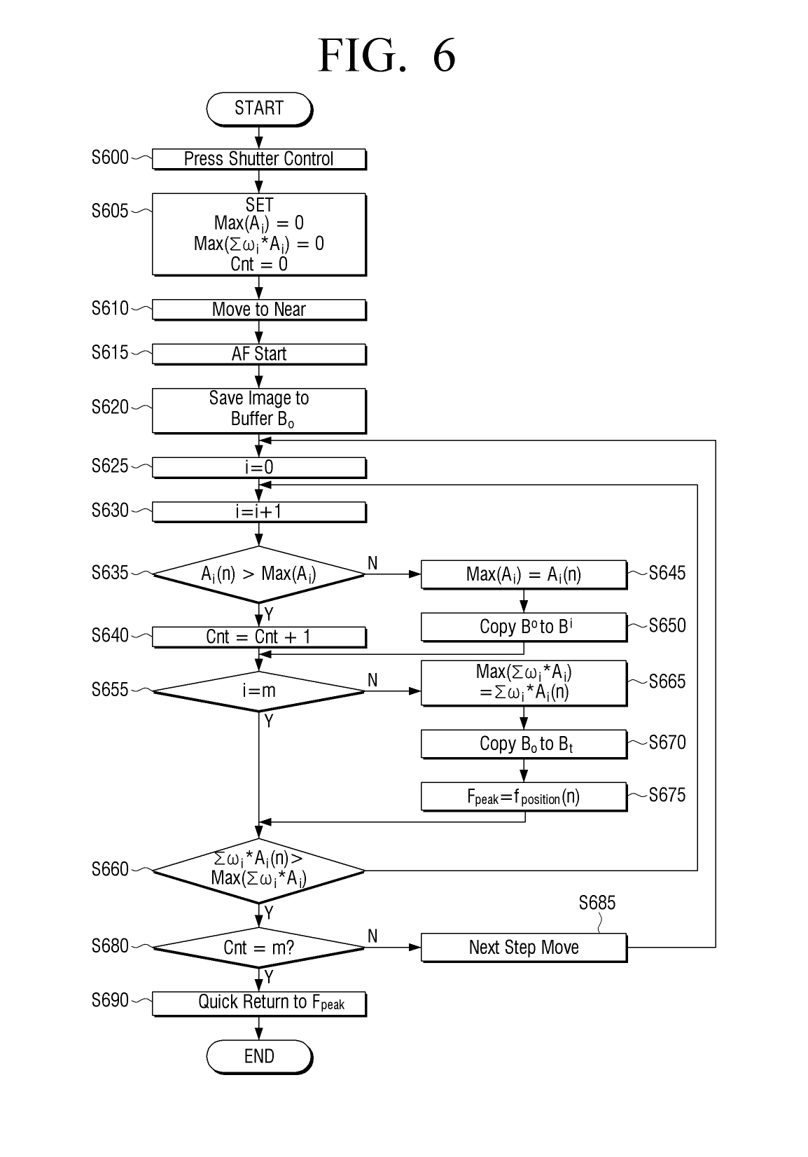

Meanwhile, FIG. 6 is a flow chart illustrating a method for photographing an image according to an exemplary embodiment.

When the shutter control 130 is disposed outside of the image photographing apparatus 100 in a form of a button, and a user command of pressing the shutter control 130 is input from a user (S600), the image photographing apparatus 100 initializes the AF evaluation value and the value equal to the sum of the obtained AF evaluation values multiplied by predetermined weight values in order to analyze the AF evaluation value (S605). In addition, a focus lens position of the image photographing apparatus 100 moves to a point where a subject is closest to the image photographing apparatus 100 (S610), and starts to analyze the AF evaluation value (S615).

The image photographing apparatus 100 stores an image of a point where the analysis of the AF evaluation value is started in a buffer B₀ (S620), and sets the point stored in the buffer B₀ as i=0 (S625). In addition, when moving to a next area, the image photographing apparatus 100 adds 1 to i (S630). To be specific, when the image photographing apparatus 100 moves to a first area for detecting a focus position, the point becomes i=1. In the first area, the image photographing apparatus 100 determines whether a value is Aᵢ(n)>Max(Aᵢ) or not (S635). That is, A refers to an AF evaluation value. Accordingly, the image photographing apparatus 100 detects a point where the AF evaluation value is highest while moving a position on an image.

When it is determined that the value is not Aᵢ(n)>Max(Aᵢ), that is, when it is determined that the image photographing apparatus 100 passed a maximum value in the first area, the image photographing apparatus 100 obtains an image corresponding to a focus point where an AF evaluation value has a maximum value (S645) and stores the image in a buffer (S650). The process of obtaining an image corresponding to a focus point where an AF evaluation value has a maximum value in each of the aforementioned areas and storing the image in a buffer is repeated by m times for a predetermined m areas.

When it is determined that an image corresponding to a focus point where an AF evaluation value has a maximum value is obtained in m areas (S655), the image photographing apparatus 100 determines whether the focus point is a point where a value equal to the sum of obtained AF evaluation values Aᵢ multiplied by predetermined weight values ωᵢ has a maximum value (S660), obtains an image corresponding to a focus point where the AF evaluation value has a maximum value (S665), and stores the image in the buffer (S670). In addition, image photographing apparatus 100 sets a focus position where a value equal to the sum of obtained AF evaluation values multiplied by predetermined weight values ωᵢ becomes a maximum value as Fₚₑₐₖ (S675).

When it is determined that the process of detecting a position where an AF evaluation value has a maximum value in each area and a position where a value equal to the sum of obtained AF evaluation values Aᵢ multiplied by predetermined weight values ωᵢ has a maximum value is repeated while passing through all of the predetermined m areas (S680-Y), the image photographing apparatus 100 moves a position of a focus lens to the position of Fₚₑₐₖ (S690).

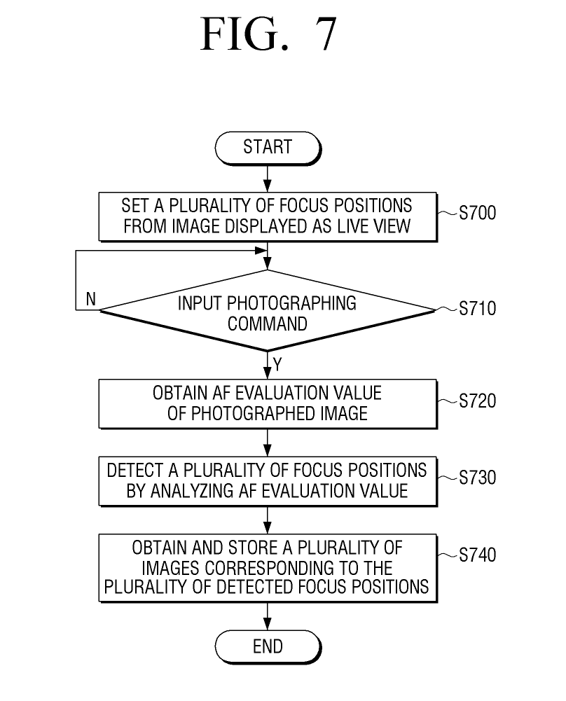

FIG. 7 is a flow chart illustrating a method for photographing an image according to another exemplary embodiment.

The image photographing apparatus 100 sets a plurality of focus positions from an image displayed as a live view (S700). That is, the plurality of focus positions may be set automatically by a method of detecting a subject or a method of detecting a person, and may be set by a user selection. For example, when the display 120 includes a touch panel, the plurality of focus positions may be set by a user command of selecting at least one of a plurality of areas where a user wishes to detect a focus position through the touch panel.

In addition, the image photographing apparatus 100 determines whether a photographing command is input (S710). When the shutter control 130 is disposed outside of the image photographing apparatus 100, the photographing command may be input by pressing or touching the shutter control 130. Alternatively, when the image photographing apparatus 100 includes a microphone, the photographing command may be input by a user voice such as ‘click’ or ‘kimchi,’ etc.

When it is determined that the photographing command is input (S710-Y), the image photographing apparatus 100 obtains an AF evaluation value of the photographed image (S720). In addition, the image photographing apparatus 100 detects a plurality of focus positions by analyzing the AF evaluation value (S730).

To be specific, the AF evaluation value is a frequency value having a high value when a subject is accurately focused. Accordingly, in an area which is set as an area in which a focus position is to be detected as one of a plurality of focus positions, the AF evaluation value of a position where a subject is accurately focused increases to be the highest value. Accordingly, the image photographing apparatus 100 analyzes the AF evaluation value, and detects a position where a slope becomes 0, that is, a position having an inflection point while moving from the first focus point to the second focus point of the image when the photographing command is input. That is, the image photographing apparatus 100 detects a position where the AF evaluation value has a maximum value in each of the set areas as a focus position which a focuses a subject of the set area accurately.

In addition, the image photographing apparatus 100 obtains and stores a plurality of images corresponding to the plurality of detected focus positions (S740).

The method for photographing an image of the image photographing apparatus according to the aforementioned various exemplary embodiments may be coded as software and stored in a non-transitory readable medium. The non-transitory readable medium may be mounted and used on various devices.

For example, a program code for executing a process of setting a plurality of focus positions from an image displayed as a live view, a process of obtaining an AF evaluation value of a photographed image when a photographing command is input, a process of detecting the plurality of focus positions by analyzing the AF evaluation value, and a process of obtaining and storing a plurality of images corresponding to the plurality of detected focus positions may be stored in the non-transitory readable medium and provided. Other than the above, the method for photographing an image described in the aforementioned various exemplary embodiments may be coded as a program and stored in the non-transitory readable medium.

The non-transitory readable medium is not a medium that stores data for a short period, such as a register, a cache, or a memory, but means a medium which semi-permanently stores data and is readable by a device. To be specific, various applications and programs as described above may be stored and provided in the non-transitory computer readable medium, such as a compact disc (CD), a digital versatile disk (DVD), a hard disk, a Blu-ray disk, a universal serial bus (USB), a memory card, and a read-only memory (ROM), etc.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. Descriptions of features or aspects within each embodiment should typically be considered as available for other similar features or aspects in other embodiments unless stated otherwise. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a computer-readable media such as non-transitory magnetic storage media (e.g., magnetic tapes, hard disks, floppy disks), non-transitory optical recording media (e.g., CD-ROMs, Digital Versatile Discs (DVDs), etc.), and non-transitory solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “configuration”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A method for photographing an image by an electronic apparatus, the method comprising:
displaying an image as a live view;
setting a plurality of focus areas from the image;
when a photographing command is received, obtaining an Auto Focus (AF) evaluation value of a photographed image;
detecting a plurality of focus positions corresponding to the plurality of focus areas by analyzing the AF evaluation value; and
obtaining and storing a plurality of images corresponding to the plurality of detected focus positions.

2. The method as claimed in claim 1 further comprising:
detecting a focus position where a value equal to a sum of obtained AF evaluation values of the photographed image multiplied by predetermined weight values is a maximum,
wherein the obtaining and storing comprises obtaining and storing an image corresponding to the focus position where a value equal to a sum of obtained AF evaluation values of the image multiplied by predetermined weight values is a maximum.

3. The method as claimed in claim 1, wherein the detecting comprises detecting a focus position where the AF evaluation value has a maximum value as one of the plurality of focus positions.

4. The method as claimed in claim 2 further comprising:
displaying the plurality of obtained and stored images; and
receiving a selection of at least one image from among the plurality of displayed images,
wherein the obtaining and storing comprises storing only the selected at least one image.

5. The method as claimed in claim 1, wherein the detecting the plurality of focus positions comprises, when a command of designating a plurality of focus areas from the image displayed as a live view is received, detecting the plurality of focus positions from the designated plurality of focus areas.

6. The method as claimed in claim 2, wherein the predetermined weight values include a weight value of a highest value in a center of an image.

7. The method as claimed in claim 1, wherein the detecting comprises detecting the plurality of focus positions by analyzing the AF evaluation value while moving from a first point to a second point of the image.

8. An electronic apparatus comprising:
a photographing unit configured to photograph an image;
a display configured to display a live view and a photographed image;
a shutter control configured to receive a photographing command;
a storage configured to store the image;
an image processor configured to obtain and analyze an Auto Focus (AF) evaluation value of the image when the photographing command is received, and detect a plurality of focus positions from the image; and
a controller configured to control the apparatus to obtain a plurality of images corresponding to the plurality of detected focus positions and store the plurality of images in the storage.

9. The apparatus as claimed in claim 8, wherein the image processor detects a focus position where a value equal to a sum of obtained AF evaluation values of the image multiplied by predetermined weight values is a maximum, and
wherein the controller controls the apparatus to obtain and store an image corresponding to the focus position where a value equal to the sum of the obtained AF evaluation values of the image multiplied by predetermined weight values is a maximum.

10. The apparatus as claimed in claim 8, wherein the image processor detects a position where the AF evaluation value has a maximum value as one of the plurality of focus positions.

11. The apparatus as claimed in claim 9 further comprising:
a user input unit,
wherein the user input unit, when the plurality of obtained and stored images are displayed through the display, receives a selection of at least one image from among the displayed images, and
wherein the storage stores only the selected at least one image.

12. The apparatus as claimed in claim 8, wherein when a command of designating a plurality of areas from the image displayed as a live view is received, the image processor detects the plurality of focus positions from the designated plurality of areas.

13. The apparatus as claimed in claim 9, wherein the predetermined weight values include a weight value of a highest value in a center of an image.

14. The apparatus as claimed in claim 8, wherein the image processor detects the plurality of focus positions by analyzing the AF evaluation value while moving from a first point to a second point of the image.
